(19) United States
(12) Patent Application Publication
(10) Pub. No.: US 2006/0165358 A1
(43) Pub. Date: Jul. 27, 2006

(54) Compact bundles of light guides with sections having reduced interstitial area

(75) Inventors: Tilmann Trebst, Bonn (DE); Alexander Harschack, Bad Honnef (DE); Wolfgang Neuberger, Labuan (MY)

Correspondence Address: Bolesh J. Skutnik, Ph D, JD, 515 Shaker Road, East Longmeadow, MA, 01028, US

(73) Assignee: CeramOptec Industries, Inc.

(21) Appl. No.: 11/321,829

(22) Filed: Dec. 29, 2005

Related U.S. Application Data
(60) Provisional application No. 60/645,693, filed on Jan. 21, 2005.

(51) Int. Cl. G02B 6/04; G02B 6/06

(52) U.S. Cl. 385/115; 385/116; 385/121

(57) ABSTRACT

A fiber optic connection system including one or more fiber optic bundles for highly efficient collection, transmission and/or distribution of optical radiation is disclosed. For each bundle, the cladding thickness is reduced or removed along a portion of each fiber, forming uncladded or reduced cladding fiber sections or ends, and the unclad or reduced cladding fiber sections/ends are pressed or fused to form intimate core contact section. The intimate core contact section may optionally be coated with a cladding material. The resulting bundle consists substantially or exclusively of optical fiber cores, with little or no interstitial area. The bundles of the present invention thus provide the ability to transmit optical radiation to or from the fiber optic bundles, or between bundles, with little or no loss of power. Further, optical terminations may be included on the ends of these bundles to increase the input energy into the bundle or distribute the energy to other sources. Also provided are radiation distribution systems utilizing one or more bundles to distribute radiation to or from a plurality of light guides. Radiation combining, collecting and distribution systems, as well as methods of manufacturing these bundles are also provided.

### DOMESTIC PRIORITY UNDER 35 USC 119(e)

This application claims the benefit of U.S. Provisional Application Ser. No. 60/645,693, filed Jan. 21, 2005, which is incorporated by reference herein.

### BACKGROUND OF THE INVENTION

1. Field of the Invention

The present invention relates to the field of optical fiber bundles, in particular, bundles for collecting and distributing radiation to or from a plurality of optical fibers in the bundle.

2. Information Disclosure Statement

Bundles of light guides are usually manufactured from light guides having a core and a cladding material of different refractive indices. When these light guides are fused to a solid bundle, the cladding material forms an interstitial area within the fused area. For a typical 1:1.1 ratio of the core to cladding diameter, this area accounts for about 20% of the total bundle area. FIG. 1 illustrates a typical fused fiber optic bundle, consisting of a plurality of optical fibers, each having core 101 and cladding 103. Cladding layers 103 are hot-pressed, for example, and deformed to form a solid bundle.

Such bundles can be useful for collecting light from a plurality of sources, such as the emitters of a diode laser bar, and coupling the radiation into a single light guide. They can also be useful for collecting light from a single source and distributing it to numerous locations.

In bundles emitting light through the end-face of the fused bundle, the intensity (power per area) is reduced by the interstitial area formed by the cladding of each fiber. In bundles which collect light through the fused bundle end-face, a considerable amount of light is usually lost at the end-face, because it is coupled into the claddings of the fiber. Since the jacketing away from the fused zone usually is higher indexed material which then strips the cladding of all modes within it, thus the light outside the core is lost.

GB 2191873 describes such bundles in which a multitude of fibers are fused together to form a solid bundle with small to negligible area between the individual fibers. Each fiber within the bundle is supposed to have its individual cladding material 103 to avoid mixing of light between adjacent fibers.

U.S. Pat. No. 5,881,195 discloses an optical fiber image bundle utilizing glass or plastic gradient index (“GRIN”) polymer optical fibers. Each micro-fiber in the image bundle transmits light within the fiber to an output area, and represents one pixel of the image. For small diameter plastic fibers, they can be fused together, and the bundle can be overlaid with a polymer coating. As with the other patents, imaging or communications applications require that mixing of light between adjacent fibers within the bundle has to be avoided.

U.S. Pat. No. 3,912,362 discloses a fiber optic bundle termination for optical telecommunication applications. The cladding is etched from the end portions of the fibers, and the end portions are terminated and held together within a ferrule. Reducing the cladding by etching increases the “packing fraction” since the ratio of the fiber core area to the bundle area increases. Although it is mentioned that some or all of the cladding may be etched from the fibers prior to bundling, it is an object of this invention to increase the packing fraction and reduce bundle diameter while preventing cross-talk between the fibers. Thus, it is required that there be a cladding material between the fiber cores, which may be accomplished by filling gaps between fibers with a low refractive index adhesive and/or leaving at least some portion of the cladding on each fiber to guide radiation through each fiber and prevent cross-talk.

While imaging or communications applications explicitly require that mixing of light between adjacent fibers within the bundle is avoided, efficient collection and/or distribution of light benefit from an efficient mixing of light in the fused section of the light. Especially, when homogenous light distributions are required mixing of light becomes compulsory which is prevented in above mentioned patents in which cross-talk between adjacent fibers is purposely prevented.

There exists a need for fiber optic bundles that efficiently collect light into a solid bundle and/or distribute from a bundle with minimal loss of power. The present invention addresses these needs.

### OBJECTIVES AND BRIEF SUMMARY OF THE INVENTION

It is an object of the present invention to provide highly efficient fiber optic bundles that collect/distribute radiation to and from the bundles with minimal or negligible loss of power during transfer.

It is another object of the present invention to collect light from various sources and guide the light into one bright, preferably homogenous spot.

It is another object of the present invention to take light from a large source through a larger aperture and distribute it evenly into a number of output channels with a minimum of loss at the input end of the bundle.

It is another object of the present invention to provide highly efficient fiber optic bundles that reduce or eliminate interstitial areas in the bundle to increase packing density and thus to reduce or eliminate optical power loss.

It is still another object of the present invention to provide a highly efficient fiber optic bundle that reduces or eliminates interstitial areas in the bundle by forming an uncladded or reduced cladding fiber sections/end to form an intimate core contact section for reducing or eliminating optical power loss.

Briefly stated, the present invention provides a fiber optic connection system including one or more fiber optic bundles for highly efficient collecting and/or distributing of optical radiation. For each bundle, along a predetermined portion of each fiber of said bundle, the cladding is either removed completely or the cladding is removed along a section-portion of the fiber, forming uncladded or reduced cladding fiber sections or ends, and the unclad or reduced cladding fiber sections/ends are pressed or fused to form a solid intimate core contact section. This intimate core contact section may optionally be coated with a cladding material on its outer circumference. The resulting bundle consists substantially or exclusively of optical fiber cores, with little or no interstitial area. The bundles of the present invention thus provide the ability to transmit optical radiation to or from the fiber optic bundles, or between bundles, with little or no loss of power. Further, optical terminations may be included on the ends of these bundles to increase the input energy into the bundle or distribute the energy to other sources. Due to their solid core these bundles are able to resist high temperatures and radiation levels. Also provided are radiation distribution systems utilizing one or more bundles to distribute radiation to or from a plurality of light guides. Radiation combining, collecting and distribution systems, as well as methods of manufacturing these bundles are also provided.

The above, and other objects, features and advantages of the present invention will become apparent from the following description read in conjunction with the accompanying drawings, (in which like reference numbers in different drawings designate the same elements.)

### BRIEF DESCRIPTION OF FIGURES

FIG. 1 illustrates by a cross-sectional view a typical prior art fiber optic bundle having cladding about each core;

FIG. 2 illustrates by a cross-sectional view a fiber optic bundle of the present invention;

FIG. 3 illustrates by a cross-sectional view another embodiment of the bundle of the present invention;

FIG. 4 illustrates by a side view a fiber optical bundle with multiple optical fibers thereto;

FIG. 5 illustrates by a side view a fiber optical bundle with a conical section attached to an end facet of one bundle; and

FIG. 6 illustrates a radiation collection and distribution system according to the present invention.

### DETAILED DESCRIPTION OF PREFERRED EMBODIMENTS

As used herein, the term “intimate core contact section” (“ICCS”) describes a section of a bundle of optical fibers in which, along the length of the ICCS, the cladding material has been substantially or completely removed from each fiber. The ICCS is then processed so that any interstitial spaces or material between the cores of each fiber are substantially or completely eliminated. This processing can be achieved by fusing or pressing the fibers together to remove any interstitial spaces between each fiber. The ICCS may be an end-section, in which the bundle terminates at an end-face, or may be a section along a given length of the fibers/fiber bundle.

According to a preferred embodiment of the present invention, bundles of light guides, normally being optical fibers, are made in a way so that, an intimate core contact section has only the cores of each light guide fused or pressed into a solid bundle upon which additional cladding material may be applied. The intimate core contact sections of the bundles of the present invention therefore do not exhibit the drawbacks of prior art bundles of having interstitial spaces between the cores of either cladding material or voids.

In one embodiment of the present invention, the cladding thickness is partially or substantially reduced along a predetermined portion of the length of each fiber in an intimate core contact section. In a preferred embodiment, the cladding is completely removed along a specified portion of the length of each fiber, leaving only the exposed core of each fiber along the portion. The specified portion of each optical fiber along which the cladding thickness has been reduced or removed is then pressed or fused into a solid section. In yet another preferred embodiment, the cladding along a specified portion of the length of the fiber is left intact on only those parts of the surface area of the core that are exposed after bundling and pressing/fusing the fibers.

After the cladding has been stripped from a portion of each fiber and each fiber core has been pressed or fused into an intimate core contact section (ICCS), the ICCS may be left uncoated, allowing the atmosphere around the ICCS (e.g. air or a vacuum) to serve as a cladding to guide and restrict radiation within the ICCS. Because air or other environments have a smaller refractive index than the core material, radiation can, in some instances, be effectively guided without the need for a cladding around the intimate core contact section of the bundle.

In other instances, an air cladding may not be sufficient to effectively guide radiation within the intimate core contact section (ICCS). In a preferred embodiment, an exterior cladding material is deposited on the exterior of the ICCS to aid in guiding radiation and as protection against pollution as moisture, dust or similar. This material may be any material having a lower index of refraction than that of the core material. For example, the material may be pure or fluorine doped silica, or a polymer. In yet another embodiment, the bundle is coated as a whole by a mirror or other reflective material in place of a more standard cladding material. An exterior cladding of a fluorine doped cladding can be applied by collapsing a tube of fluorine doped silica or a tube with an inner layer of fluorine doped silica over the fused section either during fusing the fibers to a bundle or after having fused the fibers to a bundle.

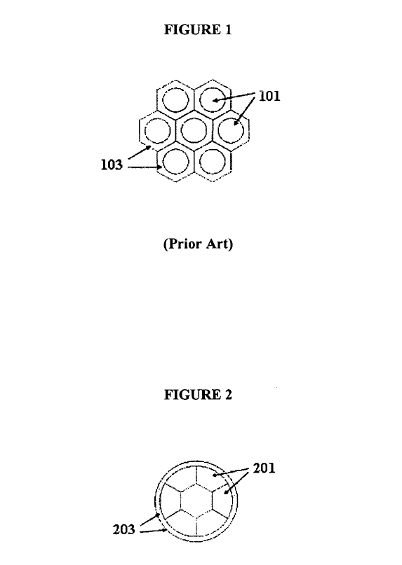

A cross section perpendicular to the axis of a preferred embodiment of the present invention is illustrated in FIG. 2. The prior art bundle 100 is shown in FIG. 1. As seen in FIG. 1, a plurality of optical fibers having cores 101 and cladding 103 thereabout are positioned in a bundle and pressed or fused together having the cladding still between cores 101 in the interstitial spaces. In FIG. 2, along a specified length of the portions of a number of optical fibers, the cladding is completely removed, exposing cores 201. Cores 201 are then pressed or fused together to form an intimate core contact section (ICCS), preferably using a hot-pressing technique, so that there is no separation between the core material of each fiber in the ICCS, and the ICCS is coated as a whole with cladding material 203. The cladding material is preferably, but not necessarily, made of the same material as the cladding initially removed from the specified portions of each fiber. The intimate core contact sections of the bundles of the present invention have no directional preference, that is light can be guided in either direction.

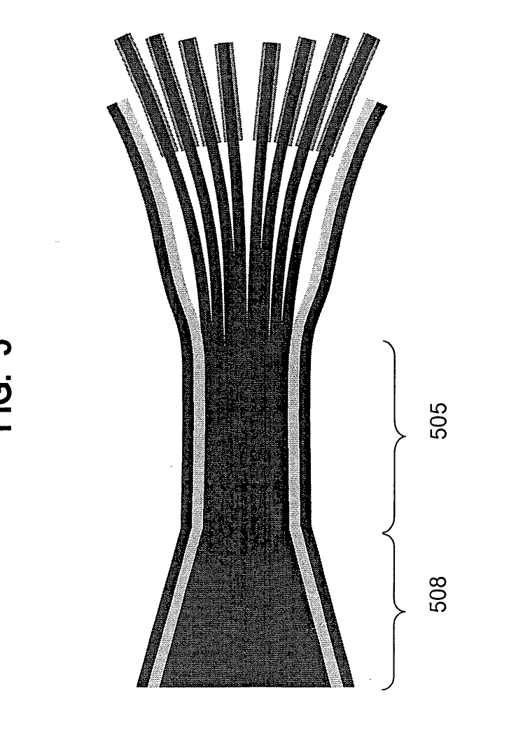

FIG. 4 is a cross sectional view taken along the axis of intimate core contact section (ICCS) 405. As seen therein, a plurality of optical fibers having cores 401 are covered with cladding 402. These form an optical fiber bundle 407. Additionally, to ensure that radiation is effectively guided through an interface 406 between the bundle 407 having the cladding 402 thereon and the ICCS 405, cladding material or the like may be melted and applied to the ends of the ICCS before the tube is removed, to fill any spaces left at the point where individual fibers transition from the fiber bundle 407 to the ICCS 405. The additional cladding material also provides a higher mechanical stability.

FIG. 5 further illustrates another feature of the present invention where a termination element 508 is connected to intimate core contact sections (ICCS) 505 which has a length on the order of the diameter of the ICCS. A typical geometry is cylindrical along the direction of the fibers of section 505. To improve coupling into or from such fused bundles 505 the shape of the ICCS may be modified. To enhance coupling and to reduce heat effects on the entrance facet of the whole assembly a conically shaped element 508 may be fused onto ICCS 505 with a larger diameter at the entrance facet converging towards the smaller diameter of the ICCS. The convergence of the diameter can be linear, parabolic or some other shape which might depend on the light profile to be coupled into the bundle.

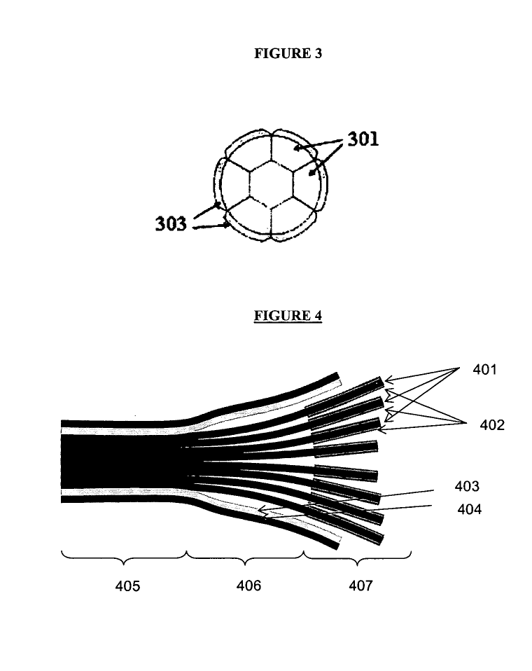

In another embodiment, the cladding is only partially removed along a specified length of a portion of each fiber, as illustrated in the cross-section shown FIG. 3. As in the previous embodiment, cores 301 are pressed or fused together to form intimate core contact section (ICCS) 405 of the bundle with reduced or eliminated interstitial area. Cladding 303, however, is only completely removed from that portion of the surface area of cores 301 that would be in contact with one another in the ICCS. Those portions of each fiber that are not in contact with other cores form the exterior of the bundle. Because cladding 303 is not removed from these portions, an exterior cladding layer is retained at the exterior of the ICCS and serves to guide radiation within the ICCS of the bundle and to protect the fused section from environmental conditions such as condensing water or other materials which deteriorate the light guiding.

In a preferred embodiment, the ICCS of a fiber optic bundle is formed from optical fibers with a quartz or silica glass core. Glass materials are preferred due to their higher damage threshold, generally their lower attenuation across a broad spectrum, their chemical stability (biocompatibility in many cases) and resultant ability to guide higher radiation power. The core may be made, for example, from pure or doped silica. Exemplary dopants include germanium and rare-earth elements. The claddings of the optical fibers may be of any material having a lower index than the core. Preferred materials include quartz, glass and polymer materials. Examples of glass cladding materials include pure silica and doped silica, such as fluorine-doped silica. For bundles made from quartz-polymer fibers, the light acceptance angle (NA) of such bundles can be considerably higher than for bundles made of quartz-quartz light guides. With highly fluorinated polymers such as Teflon the NA can be as high as 0.66. Fibers that have both core and cladding made from polymer materials are also provided.

In a preferred embodiment, the manufacturing process for producing bundles having intimate core contact sections (ICCS) of the present invention consists of a) removing each fiber cladding, b) processing the clad-less fiber cores to remove any interstitial space between them, such as by fusing or pressing the uncoated fiber cores, c) recoating of the bare fibers in the section between ICCS and their original cladding and/or coating and optionally d) recoating the ICCS with a cladding material that is preferably, but not necessarily, the same cladding material.

The manufacturing methods provided herein are applicable for creating both, radiation connectors and radiation combiners. The general steps involved in another preferred manufacturing process of the present invention are:

a) Complete (or partial) removal of the cladding thickness from a selected section along the length of each optical fiber, b) Bundling of the clad-less (or reduced cladding) fiber sections, c) insertion of at least the selected section of the bundle into a tube, preferably made from glass or polymer material, and d) processing the clad-less (or reduced cladding) fiber sections into a solid intimate core contact section, such as by heating and collapsing the clad-less (or reduced cladding) fiber sections, and also collapsing the tube around the bundle.

Processing the clad-less (or reduced cladding) fiber sections into a solid intimate core contact section may be accomplished by applying sufficient heat to melt and fuse the cores (or reduced cladding fibers) together, or by only heating to a point where the cores or fibers are softened and can be deformed by pressing them together. Such an additional external force for pressing them together can be achieved by applying low pressure (vacuum) to the tube.

The heat to melt and fuse the fiber cores among each other and with the outer tube can be reduced if the fibers have outer layer(s) and/or the tube inner layer(s) of material of lower viscosity. The lower viscosity material closes the interstitial gaps between the fibers and towards the tube at a lower temperature. The low viscosity material for the fibers has preferably the same refractive index as the core material which can be achieved for, e.g., quartz cores by appropriate doping of an outer silica layer with, e.g., fluorine and germanium simultaneously. The low viscosity material for the inner side of the tube 403 can have the same refractive index as the fiber cores but it may also have a lower refractive index to provide additionally light-guiding within the tube.

In one preferred embodiment, the collapsed tube is etched or grinded and then etched away, leaving a solid fused or pressed intimate core contact section (ICCS) of core material. The ICCS of the fiber optic bundle may be left without a solid cladding, allowing air (or other atmosphere) to guide radiation through the bundle. In another embodiment, an exterior cladding layer is applied to the exterior of the ICCS after the tube is etched away. The exterior ICCS cladding acts to restrict and guide radiation transmitted from the individual fibers through the ICCS, to ensure that the maximum amount of radiation is guided within the ICCS and to reduce losses at the transition to the individual fibers. The exterior ICCS cladding material is preferably the same material as the cladding of the individual fibers. For example, the cladding material may be pure silica or fluorine-doped silica. In a further embodiment, the collapsed tube is not removed after processing, but is retained as an exterior cladding over the intimate core contact section of the bundle.

In another preferred embodiment, a method for manufacturing an intimate core contact section of a fiber optic bundle as a combining/mixing zone for a group of optical fibers, or as a connector or illumination point, is provided. The cladding is (at least partially) etched away from each fiber along a selected length, which may be at one end of the fiber or along an interior selected section of the fiber. The clad-less (or reduced cladding) fiber sections are then bundled and inserted in a tube, preferably having an inside diameter approximating the diameter of the bundled clad-less (or reduced cladding) fiber sections. The diameter approximation may be achieved best with a slight cone in the tube. The tube is preferably of a glass or polymer material.

In one embodiment, the tube creates or is part of an airtight chamber surrounding at least the clad-less portion of the bundled fibers. The chamber is then evacuated, and heat is applied along the length of the tube surrounding the clad-less portion of the fibers. Upon sufficient application of heat, the tube portion and the clad-less fiber portions collapse, reducing the spaces between each fiber.

An optional additional step, to be performed during or after heating and collapsing the intimate core contact section (ICCS) but before the tube is removed, consists of injecting molten core material into any interstitial spaces, if necessary. The injected material should be of the same material as the fiber cores, to produce a homogeneous volume completely filled with the core material. Additionally, to ensure that radiation is effectively guided through the interface between the bundle and the ICCS, additional cladding material may be melted and applied to the ends of the ICCS before the tube is removed, to fill any spaces left at the point where individual fibers transition from the fiber bundle 407 to the ICCS 405. The additional cladding material also provides a higher mechanical stability.

Advantages of the present invention include the fact that these intimate core contact sections (ICCS) of fiber optic bundles can be produced from relatively inexpensive quartz-polymer fibers (as compared to quartz-quartz fibers). Another advantage is that the quartz-polymer intimate core contact sections of the present invention have a higher NA than other prior art bundles. Lastly, and most importantly, because the interstitial area in the bundle is extremely small, or non-existent, the losses that occur in prior art bundles due to these interstitial areas are dramatically reduced or eliminated entirely. Due to reduced geometrical losses the intensity (power per area) emitted from the ICCS of the present invention is larger than from other bundles or devices. Due to reduced losses as absorption of or scattering in the material of the interstitial area the whole bundle can withstand higher power levels and higher temperatures. The better intimate contact between the fibers provides a better heat conductance over the cross section of the bundle, thus further improving the temperature stability.

One advantageous application of the present invention is the ability to collect light from various sources (e.g., laser diodes, LEDs, (UV-)lamps) and combine it into a single exit with a cross section reduced compared to a prior art fused bundle of fibers containing a cladding in the fused section. Intimate core contact sections of bundles of the present invention, with a high acceptance angle and small interstitial area are especially useful for collecting and concentrating light from low-brightness light sources such as LED's, lamps or the sun.

The present invention is especially advantageous as a means for mixing or combining radiation from numerous optical fibers into a single waveguide and emitting or distributing radiation uniformly and homogeneously (spatially and spectrally). Because the cladding, at least in one embodiment, is removed entirely, radiation from each fiber entering the intimate core contact section (ICCS) mixes and propagates freely within the ICCS. This allows the radiation to be homogeneously combined. This is particularly useful for utilizing fiber optic bundles as sources for illuminating an area, or where it is desirable to evenly distribute radiation among numerous waveguides.

Spatial mixing of light in the ICCS can be enhanced by several (known) methods. One such method is a biconical taper which allows mixing on a very short distance. The trade-off of this method is that the numerical aperture required for guiding the light increases in the tapered region. Depending on the numerical apertures of the incoming and outgoing arms of the bundle such an increase of the numerical aperture might not be achievable except with core vs. air light guiding leaving the tapered section vulnerable to pollution. A second method utilizes a non-circular geometry (or more general a geometry without rotation-symmetry) of the ICCS or immediately afterwards. This method may readily be combined with an exterior cladding of the ICCS.

In a similar manner as described here, the core section can be a complex core, having a singlemode core embedded within a multimode core. The multi-mode core has cladding as described here and it is removed to form the fused bundle end. The single mode may be centrally embedded or off center in the multimode core. Furthermore the multimode core may be non-circular as well as non-symmetric. Also when the multimode cladding is removed, a portion or portions of the multimode core may also be removed to further diminish the cross section of the fiber bundle at the fused end.

The present invention is further illustrated by the following examples, but is not limited thereby.

### EXAMPLE 1

### Light Distribution

Due to the reduced size of the interstitial area and due to the absence of cladding material within the intimate core contact section, significantly less light is lost in the interstitial areas or in cladding modes. The present invention is thus especially useful with low-brightness light sources such as LED's (or arrays thereof). The present invention is useful for collecting light from a single or from multiple light sources and distributing it to numerous places. For example, the intimate core contact sections (ICCS) can be used to collect light from a sun concentrator towards several solar cells. In another example, one or more intimate core contact sections can be used to distribute radiation from high power lasers to several target areas, such as application fibers for medical treatments such as laser-induced LITT, photodynamic therapy (PDT), or other photo-diagnostics or therapies. This is very cost-competitive as compared to normal beam splitter based devices.

Furthermore, if the fibers of such a light distributing bundle are coated with silicone or some other low-refractive-index polymer light can also be guided in residual claddings, thus further increasing the overall efficiency of the bundle

### EXAMPLE 2

### Light Concentration

The intimate core contact sections (ICCS) of the present invention are also useful for concentrating radiation from numerous sources into a single ICCS or light guide, by terminating a plurality of light guides into a single ICCS. In a single application the light sources and the light guides do not need to be of the same type. For examples, the light sources could be of different types, such as lasers, light-emitting diodes or lamps, especially UV-lamps, and the light guides could be of different diameters.

In one example, a sun collector could be combined with several LED sources to provide illumination independent of sun irradiation, so that sufficient illumination is provided even during overcast conditions. In another example, laser sources could be combined with LED sources for aiming or pointing.

The intimate core contact section (ICCS) can have various shapes (round, rectangular, hexagonal, irregular, not limited to convex shapes). Light from several high brightness laser sources (single emitters or bars) can be delivered in a round ICCS for coupling into a single light guide, a rectangular ICCS for coupling with laser active media such as rods or thin discs, or various shapes for (back-) illumination of displays, illuminated advertisements or medical diffusers of various shapes.

The ICCS can have various shapes along the principal axis of the bundle. Collection efficiency may be increased by having a conical shape on the entrance facet of the bundle with diameters decreasing towards the other end of the bundle. This conical shape may be formed by further compression of the fused bundle with possible shaped dies or pulling. The diameter variation along the axis of the assembly may be linear (as 508) or parabolic or some other shape. Such cones may also be applied on exit facets to improve coupling to other systems. For concentrated light delivery to a small spot the ICCS may decrease in its diameter. As the NA of the guided light then increases the omission of cladding material limiting the NA in this section is preferred. Efficient coupling from/to a small spot can be accomplished by an additional droplet of index-matching liquid as well-known from microscopy.

The intimate core contact section (ICCS) of the present invention can be incorporated into a variety of radiation collection and distribution systems. Two of such intimate core contact sections can be combined to collect light from a number of sources and redistribute it to a number of destinations. The number of sources (N) and the number of destinations (M) do not need to be equal (N≈M or N=M). An intermediate ICCS of sufficient length can provide an equalization of power and spectral density in the exiting light guides. The collection/distribution system can have one or more intimate core contact sections on both ends with a multitude of separate light guides in between.

### EXAMPLE 3

### Radiation Collection/Distribution System

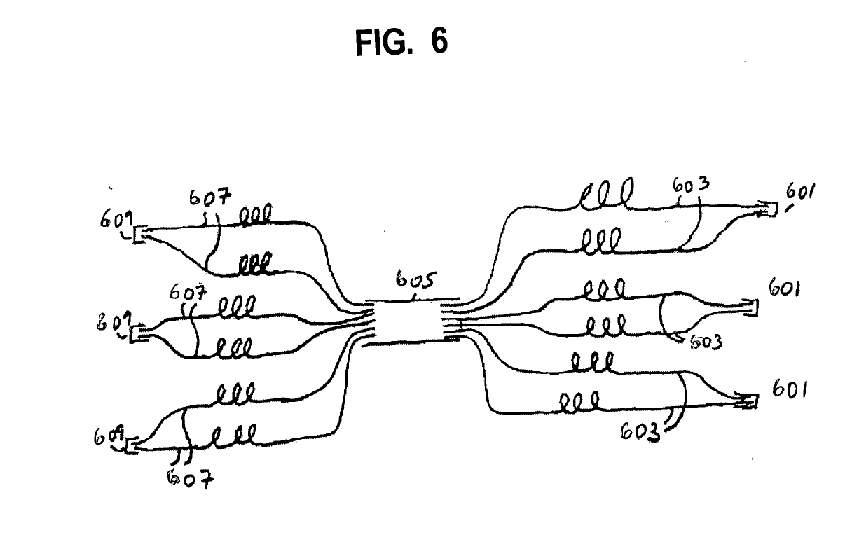

FIG. 6 depicts an example of a radiation collection and distribution system utilizing the intimate core contact sections of the present invention. A tree of entrance intimate core contact sections 601 (“entrance sections”) is shown, in which a given number of entrance sections 601 split up into a multitude of light guides 603. The number of light guides 603 does not need to be the same as the number of light guides within the entrance sections 601. Light guides 603 terminate in single intermediate mixing intimate core contact section 605 (“intermediate section”). Intermediate section 605 may be of sufficient length to ensure that each exit light guide 607 receives radiation of equal power and spectral density. Intermediate section 605 splits up into or couples with a number of exit light guides 607. Exit light guides 607 need not have the same diameter or shape as each other or as entrance light guides 603. Given subsets of exit light guides 607 can then be terminated into exit intimate core contact sections 609. Additionally, the multitude of entrance light guides 603 can be routed into more than one intermediate mixing section 605. This system can be utilized in either direction; radiation can be introduced in sections 609 and distributed through sections 601.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

What is claimed is:

1. A fiber optic bundle for providing enhanced combination/transmission of photonic energy, which has been gathered from multiple sources or alternatively distributes photonic energy to multiple sites from one or more sources, comprising:
a plurality of light guides, each having a core and a cladding; and
an intimate core contact section of said bundle wherein there is intimate contact between said cores;
wherein said cores are in contact along said intimate contact section with no cladding thereon or reduced cladding thereon, such that interstitial areas existing between said cores in said intimate core contact section are minimized.

1. The fiber optic bundle according to claim 0, wherein each of said light guides is an optical fiber.

2. The fiber optic bundle according to claim 0, wherein said intimate core contact section terminates in an end face.

3. The fiber optic bundle according to claim 0, wherein a sufficient thickness of said cladding material is at least partially reduced along said intimate core contact section to provide an area where ‘crosstalk’ occurs.

4. The fiber optic bundle according to claim 0, wherein the overall transmission of a fiber bundle is enhanced by a coating of low-refractive index material such as fluorine-doped silica, silicone, or Teflon onto the cladding to allow for cladding versus coating light guiding of potential cladding modes.

5. The fiber optic bundle according to claim 0, wherein said cladding is removed from a portion of a surface area of said fibers, so that said cladding remains only on those portions of said fibers that form an exterior of said intimate core contact section, wherein said portions of said cladding form an exterior cladding around said intimate core contact section.

6. The fiber optic bundle according to claim 0, wherein said core is a glassy material, and wherein said cores are fused together.

7. The fiber optic bundle according to claim 7, wherein said cladding material is a polymer, and wherein said glass is silica having a higher refractive index than said polymer.

8. The fiber optic bundle according to claim 0, further comprising an exterior cladding material surrounding said intimate core contact section and a section on each light guide between said intimate core contact section and a clad section of each light guide.

9. The fiber optic bundle according to claim 0, wherein each of said core is a complex core consisting of a singlemode core embedded in a multimode core, and wherein said cladding is a multimode cladding surrounding said complex core.

10. The fiber optic bundle according to claim 1, wherein said intimate core contact section has a conical shape.

11. The fiber optic bundles according to claim 11, wherein said conical shape of said intimate core contact section has a linearly or parabolic increasing or decreasing diameter.

12. The fiber optic bundle according to claim 1, further including a termination section attached to said intimate core contact section being essentially conically shaped.

13. A fiber optic transmission system having one or more bundles for providing enhanced combination/transmission of photonic energy, which has been gathered from multiple sources or alternatively distributes photonic energy to multiple sites from one or more sources, comprising:
a plurality of light guides, each having a core and a cladding; and
at least one intimate core contact section of said one or more bundles wherein there is intimate contact between said cores within said intimate core contact section; wherein said cores are in contact along said intimate contact section with no cladding thereon or reduced cladding thereon, such that interstitial areas existing between said cores in said intimate core contact section are minimized.

14. The fiber optic transmission system according to claim 14, wherein each of said light guides is an optical fiber.

15. The fiber optic transmission system according to claim 14, wherein said intimate core contact section terminates in an end face.

16. The fiber optic transmission system according to claim 14, wherein a sufficient thickness of said cladding material is at least partially reduced along said intimate core contact section to provide an area where ‘crosstalk’ occurs.

17. The fiber optic transmission system according to claim 14, wherein the overall transmission of a fiber bundle is enhanced by a coating of low-refractive index material such as silicone onto the cladding to allow for cladding versus coating light guiding of potential cladding modes.

18. The fiber optic transmission system according to claim 14, wherein said cladding is removed from a portion of a surface area of said fibers, so that said cladding remains only on those portions of said fibers that form an exterior of said intimate core contact section, wherein said portions of said cladding form an exterior cladding around said intimate core contact section.

19. The fiber optic transmission system according to claim 14, wherein said core is a glassy material, and wherein said cores are fused together.

20. The fiber optic transmission system according to claim 14, wherein said cladding material is a polymer, and wherein said glass is silica having a higher refractive index than said polymer.

21. The fiber optic transmission system according to claim 14, further comprising an exterior cladding material surrounding said intimate core contact section and a section on each light guide between said intimate core contact section and a clad section of each light guide.

22. The fiber optic transmission system according to claim 14, wherein each of said core is a complex core consisting of a single mode core embedded in a multimode core, and wherein said cladding is a multimode cladding surrounding said complex core.
